(19) United States
(12) Patent Application Publication
(10) Pub. No.: US 2016/0318078 A1
(43) Pub. Date: Nov. 3, 2016

(54) Treatment of water-containing ore beneficiation residues

(71) Applicant: Evonik Degussa GmbH, Essen (DE)

(72) Inventors: Annette zur Mühlen, Krefeld (DE); Joanna Ploch, Willich (DE); Jochen Kleinen, Heinsberg (DE); Scott Smith, Düsseldorf (DE)

(21) Appl. No.: 15/140,161

(22) Filed: Apr. 27, 2016

Related U.S. Application Data
(60) Provisional application No. 62/154,192, filed on Apr. 29, 2015.

(30) Foreign Application Priority Data
Apr. 29, 2015 (EP) 15165571.9

(51) Int. Cl. B09B 3/00; B01J 20/26

(52) U.S. Cl. CPC B09B 3/0008; B01J 20/261

(57) ABSTRACT

Process for treating water-containing ore beneficiation residues with superabsorbents in order to increase the complex shear modulus G* by at least 10% compared to the untreated ore beneficiation residue,

where the complex modulus G* is determined by the method defined herein,

and the superabsorbent contains, in copolymerized form,

a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and

b) preferably from 0.015 to 0.1 mol % based on the total amount of monomers of at least one crosslinker and

c) optionally one or more ethylenically and/or allylically unsaturated monomers which are different from the monomers a) and can be copolymerized therewith,

where the superabsorbent is optionally surface-treated, preferably using anticaking agents and/or plasticizers, and also is preferably surface-crosslinked.

The invention is in the field of tailings and super-absorbents. It relates to the use of superabsorbents for the treatment of tailings, preferably with a view to improving the storage of the tailings, in particular in above-ground residue stores.

For the beneficiation of ores and in the winning of metals from the ores, these are generally broken up, milled or comminuted to a particular particle size and then subjected to chemical and/or mechanical separation processes. In particular, the comminuted ores are subjected to a leaching process in which, depending on the type of ore, a treatment with, for example, alkaline or acidic solvents or another chemical or biological treatment is carried out. Gravitational separation methods are also regularly employed. Furthermore, it is possible to employ metallurgical extraction processes, e.g. from pyrometallurgy, hydrometallurgy and/or electrometallurgy.

The ore beneficiation and metal winning process in each case produces considerable amounts of residues or wastes which are referred to by the technical term “tailings” (=ore beneficiation residues). Tailings are thus residues which are obtained in the processing of ores or are mine waste which, after isolation of the ore by conventional processes such as flotation or other, for example, magnetic processes, usually has only a very low residual content of ores of value. Since deposits having low ore contents are increasingly being exploited, the volume of such tailings is continually increasing.

Tailings contain solid and liquid constituents such as process water from the ore beneficiation. The solid constituents are generally fine-grain sediments of the milled ore and minerals which are formed, for example, during leaching of the ore.

Tailings often also contain residues of the chemicals used in the extraction of metals from the ore.

The disposal of these tailings, which are obtained in considerable quantities, is an important task in ore processing and metal winning. For example, the tailings can for this purpose be placed in storage facilities, in particular in above-ground residue stores. Above-ground residue stores are also referred to as tailings storage facilities (TSF).

An important basic requirement for an above-ground residue storage facility is to ensure stable and economical storage of the beneficiation residues.

One problem in the storage of the tailings in the above-ground residue stores is that the initial strengths of the tailings are generally very low, so that the tailings flow away over a wide area. This results in a rather inefficient utilization of the area because only little of the mass can be deposited per unit area. For this reason, the masses are enclosed, for example, by means of dams which prevent the mass from flowing away; the rupture of such dams must be avoided at all costs.

For this reason, thickener processes have hitherto sometimes been used, e.g. in order to convert the relatively flowable tailings into a less flowable mass by use of water-soluble polymers as thickeners. Thickening can, for example, also be effected by filtration or separation using gravity sedimentation (gravity sedimentation separation) and also by means of cyclone precipitators and centrifuges, although this is very complicated. Thermal processes are also used for processing the tailings, which is energetically unfavorable. These processes are sometimes very costly, high capital costs have to be borne and the processes are time-consuming. Such a way of working is thus unsatisfactory.

Additives have hitherto been used rather rarely in the thickening of the tailings. The literature makes mention of, for example, calcareous sandstone mixtures or clays as additives for processing of the tailings. These have the disadvantage that they have to be used in homogeneously mixed-in form and in large quantities in order to achieve an effect. In addition, gypsum, for example, can be formed as a result of which the transport pipelines can become blocked and the entire storage process can come to a standstill. A further significant disadvantage is that the mass of the tailings is greatly increased thereby. In addition, crust formation is not reduced. The resulting masses are unstable. It is usual to find a dry crust on the outside and a very moist material underneath. If the pressure on this material becomes too great, the heap begins to spread or even slide down which depending on the amount of the stored tailings can lead to dangerous slips. Stable and economical storage of the ore beneficiation residues can unfortunately not be ensured in this way.

In the light of this background, it was an object of the present invention to provide a simple method by means of which it is possible to ensure more stable and more economical storage of the ore beneficiation residues in above-ground residue storage facilities.

It has now unexpectedly been found that the use of superabsorbents as described below for the treatment of ore beneficiation residues makes this possible by increasing the complex shear modulus G* and/or the maximum load.

The present invention therefore provides a process for treating water-containing ore beneficiation residues with superabsorbents in order to increase the complex shear modulus G* at a shear stress of 1 Pa (preferably up to a shear stress of 80% of the maximum shear stress which can be achieved on the untreated ore beneficiation residue, i.e. preferably up to a shear stress of 80% of the maximum load on the untreated ore beneficiation residue), by at least 10%, preferably at least 30%, in particular at least 50%, compared to the untreated ore beneficiation residue,

wherein the value of the complex shear modulus G* of the untreated ore beneficiation residue at a shear stress loading of 1 Pa is preferably at least 500 Pa, more preferably at least 750 Pa, in particular at least 1000 Pa,

where the complex modulus G* is determined by the method defined herein,

and the superabsorbent contains, in copolymerized form,

a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and

b) preferably from 0.015 to 0.1 mol % based on the total amount of monomers of at least one crosslinker and

c) optionally one or more ethylenically and/or allylically unsaturated monomers which are different from the monomers a) and can be copolymerized therewith,

where the superabsorbent is optionally surface-treated, preferably using anticaking agents and/or plasticizers, and also is preferably surface-crosslinked.

The invention likewise provides a process for treating water-containing ore beneficiation residues with super-absorbents in order to increase the maximum load by at least 10%, preferably at least 25%, in particular at least 50%, compared to the untreated ore beneficiation residue,

wherein the value of the maximum load on the untreated ore beneficiation residue is preferably at least 25 Pa, advantageously at least 50 Pa, more preferably at least 65 Pa, in particular at least 85 Pa,

wherein the maximum load is determined by the method defined herein,

and the superabsorbent contains, in copolymerized form,

a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and

b) preferably from 0.015 to 0.1 mol % based on the total amount of monomers of at least one crosslinker and

c) optionally one or more ethylenically and/or allylically unsaturated monomers which are different from the monomers a) and can be copolymerized therewith,

where the superabsorbent is optionally surface-treated, preferably using anticaking agents and/or plasticizers, and also is preferably surface-crosslinked.

Ore beneficiation residues which have been treated according to the invention are stable and able to be stored economically in above-ground residue storage facilities. They can form a stable structure particularly quickly. They display improved drying behavior since formation of a surface crust is prevented and the drying of deeper or internal layers is thus also improved.

Ore beneficiation residues which have been treated according to the invention advantageously also display improved transport behavior, in particular in respect of the pumping behavior. Sedimentation of relatively large particles often occurs during the pumping of tailings. It has now surprisingly been found that the superabsorbent addition according to the invention can effectively reduce sedimentation.

The transport of the ore beneficiation residues by means of goods vehicles is also improved. As a result of the superabsorbent addition according to the invention, a stable structure is formed in the tailings. As a result, only at high loads (e.g. tipping of the tailings) does deformation and thus flow of the tailings occur, while smaller loads on the tailings, e.g. during loading of the goods vehicle and during transport of the tailings in the goods vehicle, do not lead to flow. This counters contamination of the environment during transport by means of goods vehicles.

Transport by means of conveyor belts is also improved. The superabsorbent addition according to the invention results in formation of a stable structure in the tailings, which has a positive effect on transport of the tailings by means of conveyor belts. The tailings can be transported on steeper conveyor belts since they flow only under a relatively great load. As a result of the conveyor belts being able to be made steeper, fewer conveyor belts have to be used in order to overcome a particular height difference. A further advantage is associated with this. Due to the greater angle of inclination, more liquid drains from the tailings, so that a smaller mass has to be transported, associated with improved energy efficiency. In addition, the lower water content has a positive effect on the angle of the deposited tailings.

The processing of the “dry stacked tailings” is also aided. “Dry stacked tailings” are dewatered tailings which can be stacked for disposal.

The superabsorbent addition according to the invention reduces the flowability of the tailings. The dry stacking process can be employed more simply as a result. The superabsorbent addition according to the invention makes it possible to erect higher stacks. The superabsorbent addition according to the invention allows stacking even with decreased dewatering.

Furthermore, improved storage properties are obtained according to the invention, in particular in respect of the resistance to wearing away of the ore beneficiation residues by wind, freezing and/or water in combination with environmental influences. This also significantly reduces the formation of dust.

A further advantage of the invention is that the soil structure is loosened by the use of superabsorbents according to the invention, as a result of which the soil is less compact and thus significantly more suitable for replanting. There is also a positive effect on the water retention capacity of the soil per se.

The loosened soil structure and also the increased water retention capacity of the soil decrease the risk of dam rupture since the pressure on the dam is reduced in this way. Dam ruptures in the case of tailings can cause tremendous subsequent ecological damage since, inter alia, many tailings can contain toxicologically problematical materials.

Sand is also often added to the tailings in order to loosen the soil structure. This is problematical insofar as sand is not available everywhere in large quantities and the total mass of the tailings is increased further thereby. The use of superabsorbents according to the invention enables the optional addition of sand to be reduced or, depending on the structure of the tailings, even be omitted entirely, even though a desirable loosening of the soil structure is still achieved.

The present invention is particularly advantageous in respect of drying-out of the tailings. The particles of tailings usually have a very small particle size. They therefore tend to compact on drying. The uppermost layers dry first. A crust is formed. As a result, the drying out of the layers underneath and the inner regions is greatly hindered. This leads to the tailings not being able to be stacked so high or a longer time having to be allowed to elapse for this to be able to be done. In addition, the stacks can easily break apart, which represents a great safety risk. The use according to the invention of superabsorbents surprisingly makes it possible for even lower layers and inner regions to dry significantly better and more quickly.

A further advantage of the superabsorbent addition according to the invention is that superabsorbents are essentially insoluble in water. A disadvantage of agents used hitherto for the treatment of tailings is that these are often at least partially soluble in water or, for example, contain water-soluble polymers. Such agents can easily be dissolved when water enters, e.g. as a result of rain, and can then be washed out and discharged. In contrast, the superabsorbents used according to the invention remain in place since they are insoluble in water.

A further advantage of the superabsorbent addition according to the invention concerns the stability of superabsorbents. Many alternative materials are quickly decomposed by microorganisms or environmental influences, e.g. at elevated temperatures, so that a possible stabilizing effect on the tailings can quickly be lost. This is associated with tremendous problems. On the other hand, the superabsorbent addition according to the invention provides very good long-term stabilization since superabsorbents used according to the invention are biodegraded only with great difficulty and also remain effective in the presence of microorganisms and under extreme environmental influences.

An additional advantage of the present invention is that when tailings are handled the fine materials are usually separated from coarse materials in such a way that the tailings having smaller particles are carried outward since the coarser particles sediment more quickly. This sedimentation can be effectively prevented by the superabsorbent addition according to the invention. This results in a more homogeneous distribution and larger quantities can be stored more stably in a particular area.

Superabsorbents are used in the process of the invention. Superabsorbents are known per se. For the purposes of the present invention, they are, in particular, water-insoluble, crosslinked polymers which are able to absorb large amounts of aqueous liquids with swelling and formation of hydrogels and retain the liquids under a particular pressure. For the purposes of the present invention, they are, in particular, present in the form of discrete particles, as particle aggregates or in combinations thereof, and can comprise particles which are suspended in a liquid. Superabsorbents used according to the invention preferably absorb at least 100 times their own weight of water. Further details regarding superabsorbents and a general description of superabsorbents are disclosed in “Modern Superabsorbent Polymer Technology”, F. L. Buchholz, A. T. Graham, Wiley-VCH, 1998”, which is hereby incorporated by reference in its entirety.

The superabsorbents used according to the invention comprise, in copolymerized form, at least 50 mol %, based on the superabsorbent, of one or more monoethylenically unsaturated monomers which contain acid groups and can be neutralized partially or completely, preferably partially.

The monoethylenically unsaturated monomers containing acid groups are preferably at least partially neutralized, in particular neutralized to an extent of 15-85 mol %, in order to ensure improved water absorption.

Examples of suitable monomers for producing super-absorbents which can be used according to the invention are acrylic acid, methacrylic acid, vinylsulfonic acid, vinylphosphonic acid, crotonic acid, maleic acid, maleic anhydride, itaconic acid, fumaric acid, 2-acrylamido-2-methylpropanesulfonic acid, 2-acrylamido-2-methylpropanephosphonic acid and other monomers known from the prior art. The monomers can be used alone or in admixture with one another.

Preferred monomers which can be used are acrylic acid, methacrylic acid, vinylsulfonic acid, 2-acrylamido-2-methylpropanesulfonic acid or mixtures of these acids, for example mixtures of acrylic acid and methacrylic acid, mixtures of acrylic acid and 2-acrylamido-2-methylpropanesulfonic acid or mixtures of acrylic acid and vinylsulfonic acid. Particular preference is given to acrylic acid.

The acid groups in the monomers are preferably at least partially neutralized. The neutralization can be carried out before, during or after the polymerization in all apparatuses suitable for this purpose. Neutralizing agents which can be used are, for example, alkali metal bases, ammonia or amines. Preference is given to using sodium hydroxide, potassium hydroxide or lithium hydroxide. The neutralization can also be carried out by means of sodium carbonate, sodium hydrogencarbonate, potassium carbonate or potassium hydrogencarbonate or other carbonates or hydrogen-carbonates or ammonia. In addition, primary, secondary and tertiary amines, for example, can also be used.

Furthermore, it is possible to use comonomers in the production of the superabsorbents to be used according to the invention. Such comonomers are, in particular, capable as hydrophilic or hydrophobic monomers of being reacted with the abovementioned monomers, e.g. by polymerization, grafting or other methods.

The superabsorbents to be used according to the invention are crosslinked by use of preferably from 0.015 to 0.1 mol %, based on total monomer, of crosslinker. Crosslinking is effected by formation of covalent or ionic bonds or by formation of other attractive interactions between the polymer chains.

Compounds which, in particular, have at least two polymerizable double bonds can function as crosslinkers. Examples of compounds of this type are N,N′-methylenebisacrylamide, polyethylene glycol diacrylates and polyethylene glycol dimethacrylates, which are in each case derived from polyethylene glycols having a molecular weight of, for example, from 106 to 8500, preferably from 400 to 2000, trimethylol-propane triacrylate, trimethylolpropane trimethacrylate, ethylene glycol diacrylate, ethylene glycol dimethacrylate, propylene glycol diacrylate, propylene glycol dimethacrylate, butanediol diacrylate, butanediol dimethacrylate, hexanediol diacrylate, hexanediol dimethacrylate, allyl methacrylate, diacrylates and dimethacrylates or block copolymers of ethylene oxide and propylene oxide, polyhydric alcohols such as glycerol, trimethylolpropane or pentaerythritol which are doubly or multiply esterified with acrylic acid or methacrylic acid, triallylamine, dialkyldiallylammonium halides such as dimethyldiallyl-ammonium chloride and diethyldiallylammonium chloride, tetraallylethylenediamine, divinylbenzene, diallyl phthalate, polyethylene glycol divinyl ethers of polyethylene glycols having a molecular weight of, for example, from 106 to 4000, trimethylolpropane diallyl ether, butanediol divinyl ether, pentaerythritol triallyl ether, reaction products of 1 mol of ethylene glycol diglycidyl ether or polyethylene glycol diglycidyl ether with 2 mol of pentaerythritol triallyl ether or allyl alcohol and/or divinylethylene urea. Preference is given to using water-soluble crosslinkers, for example N,N′-methylenebisacrylamide, polyethylene glycol diacrylates and polyethylene glycol dimethacrylates, vinylethers of addition products of, for example, from 2 to 400 mol of ethylene oxide and 1 mol of a diol or polyol, ethylene glycol diacrylate, ethylene glycol dimethacrylate, triacrylates and trimethacrylates of addition products of, for example, from 6 to 20 mol of ethylene oxide and 1 mol of glycerol, trimethylolpropane or pentaerythritol triallyl ether and/or divinyl urea.

The production of superabsorbents by polymerization is known per se. Many suitable polymerization methods for producing superabsorbents are known from the prior art, in particular spray polymerization, droplet polymerization, polymerization in aqueous solution, HIPE polymerization and reverse phase suspension polymerization.

Superabsorbents which are obtainable by means of a belt reactor as described, for example, in DE3544770 or in a kneader as described, for example, in WO 03/022896, by reverse phase suspension polymerization, for example as described in EP1609810, or via droplet polymerization as described in WO2008009598 are particularly suitable for the purposes of the present invention.

Polymerization initiators of use in the production of the superabsorbents to be used according to the invention are known from the prior art and are selected according to the type of polymerization. Preference is given to free-radical initiators, photolytic polymerization initiators, thermally decomposing polymerization initiators and redox polymerization initiators and mixtures thereof. A redox system, in particular consisting of hydrogen peroxide, sodium peroxodisulfate and ascorbic acid, can particularly preferably be used for producing the water-absorbing polymer structures.

Preferred superabsorbent production processes lead to particulate superabsorbent polymers. The resulting particle or aggregate has a particle size of preferably from 45 to 1000 μm, advantageously from 45 to 850 μm, more preferably from 100 to 800 μm and in particular from 100 to 700 μm. Depending on the process, this particle size can be set directly in the production process or be obtained by milling and/or classification processes.

The superabsorbents to be used according to the invention can be surface- or after-crosslinked in order to improve their performance. This type of crosslinking and the way in which it is carried out are known per se to a person skilled in the art. It brings about

Surface-crosslinking is generally brought about by addition of an organic or inorganic after-crosslinking agent to the previously crosslinked base polymer particles. The after-crosslinking agent is not subject to any particular restrictions. Preferred after-crosslinking agents are polyhydric alcohol compounds, oxazolidinone compounds, epoxides or diglycidyl ethers and alkylene carbonate compounds; ion-reactive crosslinking agents are, for example, polyvalent metal salts or polyamine polymers and also combinations thereof.

Preference is also given to the superabsorbent polymer to be used according to the invention being subjected to an after-treatment step in order to prevent caking or lump formation. Such treatments are known in the technical field and can be carried out at any time after the polymerization, including before, during or after the freely chosen surface after-crosslinking process. The order in which the optional after-treatment agents are added is not subject to any restriction. Examples of additives which can be used for reducing caking and/or to impart other desirable properties encompass both water-soluble and water-insoluble polyvalent metal salts, water-soluble cationic polymers, inorganic particles such as silicas, zeolites or clays, surface-active compounds, hydrocarbons, thermoplastics and the like.

The superabsorbents to be used according to the invention can also contain additional components which are often present in superabsorbent polymers, for example optionally biocide, antimicrobial and/or antibacterial substances, stabilizers, antioxidants, leveling agents, antidust agents, complexing agents and/or further auxiliaries.

In a preferred embodiment of the process of the invention, the ore beneficiation residue to be treated has a water content of from 10 to 90% by weight, preferably from 10 to 50% by weight, in particular from 10 to 35% by weight.

In a further preferred embodiment of the process of the invention, the ore beneficiation residue to be treated has a solids content of from 10 to 90% by weight, preferably from ≧60 to 90% by weight, in particular from 65 to 90% by weight.

The particle size of the superabsorbent to be used according to the invention is, in a further preferred embodiment of the process of the invention, in the range from 0.01 to 5 mm, preferably from 0.1 to 1 mm.

According to the invention, the complex shear modulus G* and/or the maximum load are increased by the addition of superabsorbent. The complex shear modulus G* and the maximum load are established and known rheometric parameters.

Moduli generally describe the ratio of force to resulting deformation. Materials having high moduli are deformed to a lesser extent at a given force or have to be subjected to a greater force in order to achieve a particular deformation. Moduli are materials constants which are determined under particular conditions (e.g. applied force).

Materials can have different deformation under different loads. The moduli are determined by carrying out oscillation measurements using a rheometer.

The force to which the sample is subjected cannot be selected at will. Above a particular force, the force (or energy) introduced into the sample is converted into deformation energy and macroscopic flow of the sample occurs. Since this measurement was carried out in oscillation (sine function), this means that the sample is subjected to a periodic load. Due to the periodic load, which is usually in the seconds range, part of the force is utilized for stopping the flowing sample before the remaining force once again accelerates the sample in the opposite direction for the rest of the oscillation period. Since the time is limited by the duration of the oscillation period, the sample can always be accelerated only to a particular maximum velocity. The maximum force which can be applied to a sample in an oscillation experiment is therefore limited. This maximum force is made up of the strength of the structure in a sample and the force which is necessary to brake a sample which flows for a particular period of time and accelerate it again. When different samples having the same mass are compared, the maximum achievable load is a measure of the structure prevailing in the sample. Unlike loading in oscillation, the (shear) load in rotation is unrestricted since the sample in rotation is not braked by the change in direction associated with oscillation.

The complex shear modulus G* can be obtained from rheological measurements. The complex shear modulus G* describes, in oscillation rheometry, the behavior of viscoelastic bodies subjected to an oscillating (sinusoidal) shear load. It links the sinusoidal shear stress i(t) acting on the sample with the resulting shear deformation γ(t). The frequency with which the oscillation is carried out is 1 Hz.

G*=τ(t)/γ(t).

A higher value of the complex shear modulus G* and/or an increase in the maximum loadability (maximum load) alters the properties in such a way that, for example, a significant increase in the “beach slope” is made possible, so that significantly more mass can be deposited per unit area. “Beach slope” is an established technical term in relation to tailings. Tailings form a surface incline after they are deposited at a deposition site. The unit for the angle of inclination is given in %. The higher the percentage, the steeper the inclination. The value can, in particular, be in the range from 0.4 to 20%. Higher inclination values are desirable in order to make space-efficient deposition possible.

The measurements of the complex shear modulus are, for the purposes of the present invention, carried out, in particular, by means of periodically oscillating motion of the measurement geometry in the sample. The frequency of this oscillation is typically in the region of 1 Hz. The magnitude of the loads normally ranges over a number of orders of magnitude. Macroscopic movement of the measurement geometry at a particular load means that the energy introduced into the sample has been converted into deformation energy. The deformation destroys the internal structure of the sample and it is possible to store only little deformation energy, so that the load applied to the sample leads to movement of the entire sample. The load required for movement of the entire sample can be smaller than the load originally set by the operator, and the rheometer therefore cannot impart this load to the sample. The nonachievement of a high load thus indicates that the materials properties of the sample are insufficient for taking up this load. Samples in which no high loads have been able to be achieved or whose moduli have become very small at high loads display a low beach slope.

For the purposes of the present invention, recourse was made to the test methods described below.

An MCR 302 rheometer from Anton Paar, Graz, was used for the measurements. Peltier temperature control for cylinder measurement systems (C-PTD 200) as accommodation for disposable cylinders was utilized; as geometry, the geometry ST 24-2D-12/109 was used. This geometry is akin to a blade stirrer and consists of a 107.45 mm long axle at the ends of which two 12 mm×12 mm metal sheets are attached at an angle of 45°. The measurement temperature was 25° C.

50 (+/−1) gram of the shaken-up samples were introduced into the disposable cylinders and stirred a number of times with a spatula in order to destroy any air bubbles present. After 5 minutes, the sample was inserted into the Peltier element. The measurement geometry was subsequently moved to the lowest position which could be selected by the software.

The following measurement program was subsequently started:

1.: Application of a shear stress of 1000 pascal with 2 measurement points, 5 seconds per measurement point

2.: After a delay time of 50 seconds, a shear stress ramp of 1-1000 pascal and a frequency of 1 Hz with 31 measurement points (logarithmic scale) was applied, 5 seconds per measurement point

The first part of the measurement program has the task of always giving the samples the same pretreatment and equalizing any effects occurring as a result of sedimentation. The measurements were carried out in rotation. All measured samples displayed the formation of a vortex which indicates good and complex mixing of the sample in a manner similar to that which would be experienced during pumping through pipes.

The second part of the measurement program tests the properties of the sample in respect of deformability under different, increasing loads. None of the samples examined could be loaded with a load of 1000 pascal since all samples flowed completely at lower loads. The complex shear modulus and the maximum load (corresponding to the maximum achievable shear stress) were employed for the evaluation.

The addition of the superabsorbent was effected by weighing the polymer into the disposable tubes and subsequently adding 50 (+/−1) gram of the shaken-up sample thereto. The sample was mixed with a spatula, placed in the Peltier element after 5 minutes and the measurement program was commenced.

The complex shear modulus was evaluated at various shear stress loads (oscillation shear stress). In addition, the maximum shear stress loads (maximum load) with which the samples were loaded were noted.

Unless other test methods are prescribed below, recourse was also made, for the purposes of the present invention, to the test methods which are generally known to those skilled in the art and appear to be customary; in particular, test methods of the EDANA (European Diaper and Nonwoven Association), which are generally referred to as “ERT methods”, are employed.

The process of the invention provides for the treatment of water-containing ore beneficiation residues with a specific superabsorbent, as described above.

Here, the ore beneficiation residue can, for example, be treated stepwise or with a one-shot addition with the superabsorbent.

In a preferred embodiment of the invention, the water-containing ore beneficiation residues are treated stepwise with superabsorbent by, for example, adding a first amount of superabsorbent at the beginning of the transport process, which is, for example, effected by pumping, corresponding to stage 1, and then immediately before discharge at the storage site adding more superabsorbent, corresponding to stage 2. There are therefore at least 2 addition places and/or points in time of addition.

It is possible, for example, to introduce part of the superabsorbent at the beginning of the pipeline into the “suction” section and introduce the remainder at the end of the pipeline.

When the tailings are pumped through pipelines, the superabsorbent can, for example, be simply metered into the fluid stream. This is preferably carried out just before exit from the pipeline into the storage site (end piece of the pipeline) of the optionally thickened tailings. The turbulence, in particular on discharge into the storage site, is sufficient to distribute the polymer. Surface-treated superabsorbents in particular can easily be dispersed. This allows a separate mixing operation to be dispensed with. The superabsorbent can naturally also be mixed in by means of a mixer.

The following variants, for example, which each correspond to preferred embodiments of the invention, are possible for the addition of the superabsorbent to the tailings:

a) Via a bypass of the pipeline: there, the pressure can be controlled very well and the superabsorbent can be introduced by means of, for example, a metering screw. The treated tailings are then reintroduced into the pipeline stream. The advantage is that a relatively small pump is required for the bypass.

b) The pipeline is interrupted and the tailings flow into a feed hopper in which the superabsorbent is introduced and mixed in. The tailings are then pumped on.

c) The superabsorbent can be introduced into the pipeline with the aid of compressed air.

d) The superabsorbent can be introduced into the “suction side”.

The invention further provides mixtures comprising ore beneficiation residues and superabsorbents, in particular as defined above, wherein the mixture has a complex shear modulus G* of ≧550 Pa, preferably ≧825 Pa, in particular ≧1100 Pa, at a shear stress load of 1 Pa,

where the complex shear modulus G* is determined by the method defined herein, and/or has a maximum load in the range of ≧40 Pa, preferably ≧100 Pa, in particular ≧150 Pa,

where the maximum load is determined by the method defined herein,

and the superabsorbent contains, in copolymerized form,

a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and

b) preferably from 0.015 to 0.1 mol % based on the total amount of monomers of at least one crosslinker and

c) optionally one or more ethylenically and/or allylically unsaturated monomers which are different from the monomers a) and can be copolymerized therewith,

where the superabsorbent is optionally surface-treated, preferably using anticaking agents and/or plasticizers, and also is preferably surface-crosslinked.

In a preferred embodiment, the mixture of the invention has a beach slope of 1-45%, preferably 1-20%.

The invention further provides a method of storing ore beneficiation residues in an above-ground residue store, wherein superabsorbent is mixed into the ore beneficiation residues during introduction into the residue store or within a period of preferably not more than 5 hours before introduction into the residue store and the superabsorbent contains, in copolymerized form,

a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and

b) preferably from 0.015 to 0.1 mol % based on the total amount of monomers of at least one crosslinker and

c) optionally one or more ethylenically and/or allylically unsaturated monomers which are different from the monomers a) and can be copolymerized therewith,

where the superabsorbent is optionally surface-treated, preferably using anticaking agents and/or plasticizers, and also is preferably surface-crosslinked.

The invention further provides for the use of superabsorbents, in particular as described above, for improving the drying behavior of water-containing ore beneficiation residues, for improving the storage properties of water-containing ore beneficiation residues, in particular for improving the storage properties in respect of resistance to wearing away of the ore beneficiation residues by wind and/or water in combination with the environmental influences, and for improving the transport behavior of water-containing ore beneficiation residues.

The invention further provides for the use of super-absorbents, in particular as described above, for suppressing dust formation from ore beneficiation residues.

The invention further provides for the use of super-absorbents, in particular as described above, for reducing crust formation during drying of water-containing ore beneficiation residues.

### EXAMPLES

Superabsorbent Polymer A

0.925 g of trimethylolpropane triacrylate (ethoxylated) (0.20% based on acrylic acid; ester content=69.2%) and 1.407 g of polyethylene glycol monoallyl ether acrylate (0.40% based on acrylic acid; ester content corresponding to 91%) were dissolved as crosslinker in 985.67 g of an aqueous solution of acrylic acid having a degree of neutralization of 74 mol % (321.7 g of glacial acrylic acid in 253.26 g of deionized water, neutralized with 410.72 g of 32% aqueous sodium hydroxide solution. The monomer solution was flushed with nitrogen in a plastic polymerization vessel for 30 minutes in order to remove the dissolved oxygen. At a temperature of 4° C., the polymerization was started by successive addition of 0.3 g of sodium peroxodisulfate in 4.7 g of distilled water, 0.07 g of 35% strength hydrogen peroxide solution in 4.93 g of distilled water and 0.015 g of ascorbic acid in 1.985 g of distilled water. Thirty minutes after the final temperature (about 100° C.) has been reached, the gel was broken up by means of a meat mincer and dried at 150° C. for 2 hours in a convection drying oven. The dried intermediate was crushed coarsely, milled and sieved to give a powder 1 having a particle size of from 150 mm to 600 mm.

Superabsorbent Polymer B

The powder 1 obtained above was mixed while stirring vigorously with 500 ppm of polyethylene glycol (molecular weight 300), 2200 ppm of silica (Sipernat 22s, Evonik) and 5000 ppm of distilled water. The resulting water-absorbing polymer structure which had not been surface-after-crosslinked (powder A) had an average particle size in accordance with EDANA ERT 420.2-02 of 390 mm.

Superabsorbent Polymer C

Produced as described for superabsorbent polymer A, with the final formulation being carried out using 1.5% by weight of kaolin powder (0.1-4 μm, CAS No. 1332-58-7, Sigma-Aldrich) (dry blending).

Superabsorbent Polymer D

A monomer solution consisting of 640 g of acrylic acid which had been neutralized to a degree of 70 mol % by means of sodium hydroxide (497.36 g of 50% strength NaOH), 825.06 g of water, 2.102 g of polyethylene glycol 300 diacrylate (76.1% strength) and 4.010 g of polyethylene glycol monoallyl ether (79.8% strength, molecular weight about 440 g/mol) was freed of dissolved oxygen by flushing with nitrogen and cooled to the initiation temperature of 4° C. After the initiation temperature had been reached, the initiator solution (0.8 g of sodium peroxodisulfate in 10 g of H2O, 0.6 g of 35% strength hydrogen peroxide solution in 10 g of H₂O and 0.06 g of ascorbic acid in 10 g of H₂O) was added. After the final temperature of about 100° C. had been reached, the gel formed was broken up by means of a meat mincer and dried at 150° C. for 2 hours in a drying oven. The dried polymer was crushed coarsely, milled by means of a rotor mill (from Retsch ZMI) having a 5 mm screen and sieved to give a powder having a particle size of from 150 to 800 μm.

For after-crosslinking, 100 parts of the powder just obtained were mixed while stirring vigorously with a solution of 1 part of 1,3-dioxolan-2-one, 3 g of water and subsequently heated at 180° C. for 30 minutes. The resulting surface-after-crosslinked, water-absorbing polymer structure (powder D) had an average particle size in accordance with EDANA ERT 420.2-02 of 460 mm.

The iron ore beneficiation residues A mentioned below were made available by a mining company.

### Example 1

50 g of iron ore beneficiation residue A having a solids content of 65% by weight and comprising 0.1% by weight of linear polyacrylamide (Kemira N-100) as friction reducer were mixed with 0.035 g of superabsorbent A.

### Example 2

50 g of iron ore beneficiation residue A having a solids content of 61% by weight were mixed with 0.04 g of superabsorbent A.

### Example 3

50 g of iron ore beneficiation residue A having a solids content of 66% by weight were mixed with 0.035 g of superabsorbent A.

### Example 4

50 g of iron ore beneficiation residue A having a solids content of 60% by weight were mixed with 0.045 g of superabsorbent A.

### Comparative Example 1

50 g of iron ore beneficiation residue A having a solids content of 65% by weight and comprising 0.1% by weight of linear polyacrylamide (Kemira N-100) (corresponds to Ex. 1 without superabsorbent).

### Comparative Example 2

50 g of iron ore beneficiation residue A having a solids content of 61% by weight (corresponds to Ex. 2 without superabsorbent).

### Comparative Example 3

50 g of iron ore beneficiation residue A having a solids content of 66% by weight (corresponds to Ex. 3 without superabsorbent).

### Comparative Example 4

50 g of iron ore beneficiation residue A having a solids content of 60% by weight (corresponds to Ex. 4 without superabsorbent).

TABLE 1

| | | | | | % | | % | | | |
|---|---|---|---|---|---|---|---|---|---|---|
| | | | | G*/Pa | change | G*/Pa | change | G*/Pa | | |
| | Solids | Friction | | (1 Pa | (1 Pa | (10 Pa | (10 Pa | (100 Pa | Maximum | % |
| | content | reducer | SAP | load) | load) | load) | load) | load) | load/Pa | change |
| Comparative | 65% | + | — | 1640 | — | 510 | — | Not | 87.97 | — |
| example 1 | | | | | | | | measurable | | |
| Example 1 | 65% | + | SAP A | 3130 | 91% | 2100 | 312% | 32.7 | 184.6 | 110% |
| Comparative | 61% | — | — | 2530 | — | 1460 | — | Not | 98.63 | — |
| example 2 | | | | | | | | measurable | | |
| Example 2 | 61% | — | SAP A | 2800 | 11% | 2060 | 41% | 10.4 | 129.2 | 31% |
| Comparative | 66% | — | — | 1700 | — | 81.4 | — | Not | 66.61 | — |
| example 3 | | | | | | | | measurable | | |
| Example 3 | 66% | — | SAP A | 2950 | 74% | 1500 | 1743% | 6.6 | 137.8 | 107% |
| Comparative | 60% | — | — | 789 | — | 254 | — | Not | 51.7 | — |
| example 4 | | | | | | | | measurable | | |
| Example 4 | 60% | — | SAP A | 1240 | 57% | 504 | 98.40% | Not | 66.9 | 29% |
| | | | | | | | | measurable | | |

### Example 5

50 g of iron ore beneficiation residue A having a solids content of 60% by weight were mixed with 0.040 g of superabsorbent D.

### Example 6

50 g of iron ore beneficiation residue A having a solids content of 60% by weight were mixed with 0.040 g of superabsorbent A.

### Example 7

50 g of iron ore beneficiation residue A having a solids content of 60% by weight were mixed with 0.040 g of superabsorbent B.

### Example 8

50 g of iron ore beneficiation residue A having a solids content of 60% by weight were mixed with 0.040 g of superabsorbent C.

TABLE 2

| | | | | | % | | % | | |
|---|---|---|---|---|---|---|---|---|---|
| | | | | G*/Pa | change | G*/Pa | change | | |
| | Solids | Friction | | (1 Pa | (1 Pa | (10 Pa | (10 Pa | Maximum | % |
| | content | reducer | SAP | load) | load) | load) | load) | load/Pa | change |
| Comparative | 60% | — | — | 789 | — | 254 | — | 51.7 | — |
| example 4 | | | | | | | | | |
| Example 4 | 60% | — | SAP A | 1240 | 57% | 504 | 98% | 66.9 | 29% |
| Example 5 | 60% | — | SAP D | 1210 | 53% | 595 | 134% | 87 | 68% |
| Example 6 | 60% | — | SAP A | 1370 | 74% | 660 | 160% | 77.7 | 50% |
| Example 7 | 60% | — | SAP B | 1440 | 83% | 732 | 188% | 84.9 | 64% |
| Example 8 | 60% | — | SAP C | 1560 | 98% | 836 | 229% | 84.5 | 63% |

The nickel ore beneficiation residues A mentioned below were made available by a mining company.

### Comparative Example 5

50 g of nickel ore beneficiation residue A having a solids content of 50% by weight.

### Example 9

50 g of nickel ore beneficiation residue A having a solids content of 50% by weight were mixed with 0.040 g of superabsorbent A.

TABLE 3

| | | | | % | | % | | % | | |
|---|---|---|---|---|---|---|---|---|---|---|
| | | | G*/Pa | change | G*/Pa | change | G*/Pa | change | | |
| | Solids | | (1 Pa | (1 Pa | (4 Pa | (4 Pa | (9 Pa | (9 Pa | Maximum | % |
| | content | SAP | load) | load) | load) | load) | load) | load) | load/Pa | change |
| Comparative | 50% | — | 26.9 | — | 8.16 | — | 0.57 | | 16.7 | — |
| example 5 | | | | | | | | | | |
| Example 9 | 50% | SAP A | 86.2 | 220% | 21.3 | 161% | 1% | 86% | 19.2 | 15% |

A further series of iron ore beneficiation residues having different solids contents were obtained from a further mine. These will hereinafter be designated as iron ore beneficiation residues B.

### Example 10

35 g of iron ore beneficiation residue B having a solids content of 60% by weight were mixed with 0.050 g of superabsorbent A.

### Example 11

35 g of iron ore beneficiation residue B having a solids content of 65% by weight were mixed with 0.050 g of superabsorbent A.

### Example 12

35 g of iron ore beneficiation residue B having a solids content of 70% by weight were mixed with 0.050 g of superabsorbent A.

### Comparative Example 6

35 g of iron ore beneficiation residue B having a solids content of 60% by weight.

### Comparative Example 7

35 g of iron ore beneficiation residue B having a solids content of 65% by weight.

### Comparative Example 8

35 g of iron ore beneficiation residue B having a solids content of 70% by weight.

TABLE 4

| | | | | % | | % | | % | | |
|---|---|---|---|---|---|---|---|---|---|---|
| | | | G*/Pa | change | G*/Pa | change | G*/Pa | change | | |
| | Solids | | (1 Pa | (1 Pa | (4 Pa | (4 Pa | (10 Pa | (10 Pa | Maximum | % |
| | content | SAP | load) | load) | load) | load) | load) | load) | load/Pa | change |
| Comparative | 60% | — | 1.4 | — | 0.12 | — | — | — | 5 | — |
| example 6 | | | | | | | | | | |
| Example 10 | 60% | SAP A | 754 | 53757% | 4.23 | 3425% | — | — | 9.4 | 88% |
| Comparative | 65% | — | 701 | — | 5.8 | — | 1.4 | — | 36.1 | — |
| example 7 | | | | | | | | | | |
| Example 11 | 65% | SAP A | 2707 | 286% | 1543.5 | 26512% | 24.5 | 1650% | 57.7 | 60% |
| Comparative | 70% | — | 4090 | — | 3.2 | — | 2.1 | — | 55.3 | — |
| example 8 | | | | | | | | | | |
| Example 12 | 70% | SAP A | 26900 | 558% | 9890 | 308963% | 2.9 | 36% | 61.6 | 11% |

### Example 13

50 g of iron ore beneficiation residue B having a solids content of 75% by weight were mixed with 0.050 g of superabsorbent A.

### Comparative Example 9

50 g of iron ore beneficiation residue B having a solids content of 75% by weight.

TABLE 5

| | | | | % | | % | | % | | |
|---|---|---|---|---|---|---|---|---|---|---|
| | | | G*/Pa | change | G*/Pa | change | G*/Pa | change | | |
| | Solids | | (20 Pa | (20 Pa | (40 Pa | (40 Pa | (100 Pa | (100 Pa | Maximum | % |
| | content | SAP | load) | load) | load) | load) | load) | load) | load/Pa | change |
| Comparative | 75% | — | 1800 | | 154 | | 20.2 | | 291 | |
| example 9 | | | | | | | | | | |
| Example 13 | 75% | SAP A | 3126 | 74% | 872 | 466% | 127.5 | 531% | 824 | 183% |

1. Process for treating water-containing ore beneficiation residues with superabsorbents in order to increase the complex shear modulus G* at a shear stress of 1 Pa by at least 10%, preferably at least 30%, in particular at least 50%, compared to the untreated ore beneficiation residue,
wherein the value of the complex shear modulus G* of the untreated ore beneficiation residue at a shear stress loading of 1 Pa is preferably at least 500 Pa, more preferably at least 750 Pa, in particular at least 1000 Pa,
where the complex modulus G* is determined by the method defined herein, and the superabsorbent contains, in copolymerized form,
a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and
b) preferably from 0.015 to 0.1 mol % based on the total amount of monomers of at least one crosslinker and
c) optionally one or more ethylenically and/or allylically unsaturated monomers which are different from the monomers a) and can be copolymerized therewith,
where the superabsorbent is optionally surface-treated, preferably using anticaking agents and/or plasticizers, and also is preferably surface-crosslinked.

2. Process for treating water-containing ore beneficiation residues with superabsorbents in order to increase the maximum load by at least 10%, preferably at least 25%, in particular at least 50%, compared to the untreated ore beneficiation residue,
wherein the value of the maximum load on the untreated ore beneficiation residue is preferably at least 25 Pa, advantageously at least 50 Pa, more preferably at least 65 Pa, in particular at least 85 Pa,
wherein the maximum load is determined by the method defined herein,
and the superabsorbent contains, in copolymerized form,
a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and
b) preferably from 0.015 to 0.1 mol % based on the total amount of monomers of at least one crosslinker and
c) optionally one or more ethylenically and/or allylically unsaturated monomers which are different from the monomers a) and can be copolymerized therewith,
where the superabsorbent is optionally surface-treated, preferably using anticaking agents and/or plasticizers, and also is preferably surface-crosslinked.

3. Process according to claim 1, characterized in that the superabsorbent is added in amounts of from 0.001 to 10% by weight, preferably from 0.03 to 5% by weight, in particular from 0.05 to 3% by weight, to the ore beneficiation residue.

4. Process according to claim 1, characterized in that the ore beneficiation residue to be treated has a water content of from 5 to 90% by weight, preferably from 10 to 70% by weight, in particular from 15 to 50% by weight.

5. Process according to claim 1, characterized in that the particle size of the superabsorbent is in the range from 0.01 to 5 mm, preferably from 0.1 to 1 mm.

6. Process according to claim 1, characterized in that the ore beneficiation residue has at least 50% by weight, based on its total weight, of particle size fractions in the range from 2 pm to 2 mm.

7. Mixture comprising ore beneficiation residues and superabsorbents, in particular as defined in any of the preceding claims, wherein the mixture has a complex shear modulus G* of ≧550 Pa, preferably ≧825 Pa, in particular ≧1100 Pa, at a shear stress load of 1 Pa,
where the complex shear modulus G* is determined by the method defined herein, and/or has a maximum load in the range of ≧40 Pa, preferably ≧100 Pa, in particular ≧150 Pa, where the maximum load is determined by the method defined herein,
and the superabsorbent contains, in copolymerized form,
a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and
b) preferably from 0.015 to 0.1 mol % based on the total amount of monomers of at least one crosslinker and
c) optionally one or more ethylenically and/or allylically unsaturated monomers which are different from the monomers a) and can be copolymerized therewith,
where the superabsorbent is optionally surface-treated, preferably using anticaking agents and/or plasticizers, and also is preferably surface-crosslinked.

8. Mixture according to claim 7, characterized in that it has a beach slope of 1 20%, preferably from 1 to 10%.

9. Method of storing ore beneficiation residues in an above-ground residue store, wherein superabsorbent is mixed into the ore beneficiation residues during introduction into the residue store or within a period of preferably not more than 5 hours before introduction into the residue store
and the superabsorbent contains, in copolymerized form,
a) at least 50 mol % based on the superabsorbent of one or more monoethylenically unsaturated monomers containing acid groups, where the degree of neutralization of the monoethylenically unsaturated monomers containing acid groups is preferably from 15 to 85 mol %, and
b) preferably from 0.015 to 0.1 mol % based on the total amount of monomers of at least one crosslinker and
c) optionally one or more ethylenically and/or allylically unsaturated monomers which are different from the monomers a) and can be copolymerized therewith,
where the superabsorbent is optionally surface-treated, preferably using anticaking agents and/or plasticizers, and also is preferably surface-crosslinked.

10.-13. (canceled)
